(19) United States
(12) Patent Application Publication
(10) Pub. No.: US 2026/0049758 A1
(43) Pub. Date: Feb. 19, 2026

(54) RF DEFROSTING DRAWER

(71) Applicant: WHIRLPOOL CORPORATION, BENTON HARBOR, MI (US)

(72) Inventor: ALESSANDRO GIGANTE, VARESE (IT)

(73) Assignee: WHIRLPOOL CORPORATION, BENTON HARBOR, MI (US)

(21) Appl. No.: 18/808,200

(22) Filed: Aug. 19, 2024

(51) Int. Cl. F25D 23/12; F24C 7/02; H05B 1/02; H05B 6/58; H05B 6/62

(52) U.S. Cl. CPC F25D 23/12; F24C 7/02; H05B 1/0261; H05B 6/58; H05B 6/62

(57) ABSTRACT

An RF defrosting drawer that has a pair of electrodes for heating a food item. One or both of the electrodes may be moveable and the compartment may have a venting mechanism for removing the moisture generated by the heating of food items. The RF defrosting drawer can be positioned inside the refrigerator compartment of a refrigerator.

### BACKGROUND OF THE DISCLOSURE

The present disclosure generally relates to a radio frequency defrosting/cooking drawer. Defrosting food items can require extensive time and/or use of appliances, such as microwaves. Defrosting can lead to bacterial growth if it is not done in a safe manner. In addition, defrosting can lead to the item not being uniformly or completely defrosted. Thus, there is a need to find a way to quickly and safely defrost food items without using another appliance.

### SUMMARY OF THE DISCLOSURE

According to one aspect of the present disclosure is a refrigerator with a cooking compartment for radio frequency heating. The refrigerator has an interior cavity. The refrigerator has a cooking compartment with a cooking cavity. A first electrode is positioned in the cooking cavity, and a second electrode is positioned in the cooking cavity. A radio frequency generator supplies electromagnetic energy between the first electrode and the second electrode to heat an object in the cooking cavity. At least one wall of the cooking compartment has a plurality of openings permitting moisture to escape the cooking compartment. At least one of the electrodes is movable with respect to the other electrode.

According to another aspect of the present disclosure is a cooking compartment for radio frequency heating. The cooking compartment has a cooking cavity, a first electrode, and a second electrode. A radio frequency generator supplies electromagnetic energy between the first electrode and the second electrode to heat an object in the cooking cavity. The first electrode and the second electrode are positioned on opposite sides of the cavity. At least one of the electrodes is in a grid pattern permitting moisture to escape. At least one of the electrodes is movable with respect to the other electrode.

According to yet another aspect of the present disclosure is a defrosting compartment for a refrigerator. The defrosting compartment has a cooking cavity with a first electrode and a second electrode. A radio frequency generator supplies electromagnetic energy between the first electrode and the second electrode to heat an object in the cooking cavity. The first electrode and the second electrode are positioned on opposite sides of the cavity. The second electrode is movable with respect to the first electrode. The second electrode is coupled to a plate that is coupled to a plurality of pins that are received within openings in a wall of the cooking cavity.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of a refrigerator with a cooking compartment;

FIG. 2 is a front perspective view of the cooking compartment shown in FIG. 1;

FIG. 3 is a front perspective view of the cooking compartment shown in FIG. 1 with the door open;

FIG. 4 is a rear perspective view of the cooking compartment shown in FIG. 1;

FIG. 5 is a front view of the cooking compartment shown in FIG. 1 with the door open;

FIG. 6 is a front view of the cooking compartment shown in FIG. 1;

FIG. 7 is a top view of the cooking compartment shown in FIG. 2;

FIG. 8 is a left side view of the cooking compartment shown in FIG. 1;

FIG. 9 is a right side view of the cooking compartment shown in FIG. 1;

FIG. 10 is a front view of the cooking compartment shown in FIG. 1;

FIG. 11 is a rear view of the cooking compartment shown in FIG. 1;

FIG. 12 is a side cross-sectional view of the cooking compartment shown in FIG. 1;

FIG. 13 is another side cross-sectional view of the cooking compartment shown in FIG. 1;

FIG. 14 is a top perspective view of the electrodes, pins, and ball screw member of the cooking compartment; and

FIG. 15 is a front perspective view of the components of the cooking compartment shown in FIG. 1.

The components in the figures are not necessarily to scale, emphasis instead being placed upon illustrating the principles described herein.

### DETAILED DESCRIPTION

The present illustrated embodiments reside primarily in combinations of method steps and apparatus components related to a rotatable dishwasher rack. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

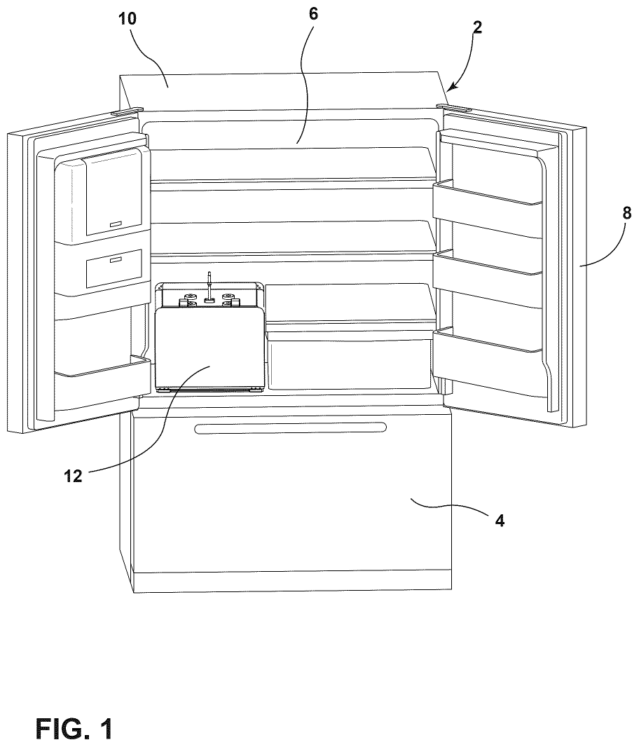

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

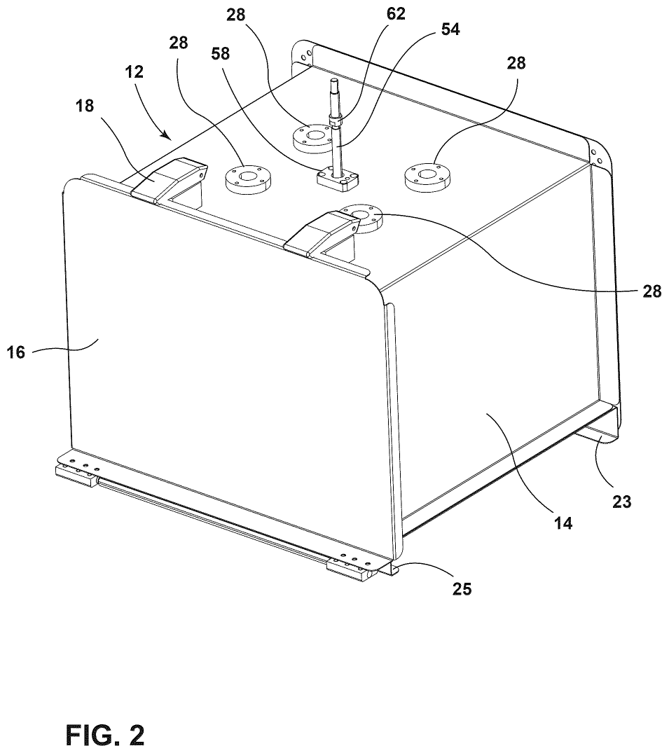

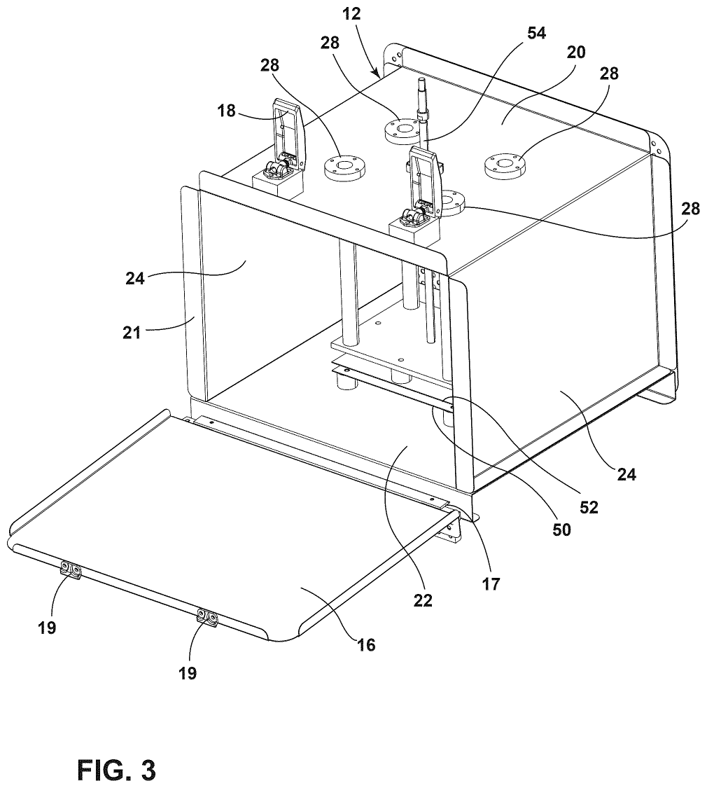

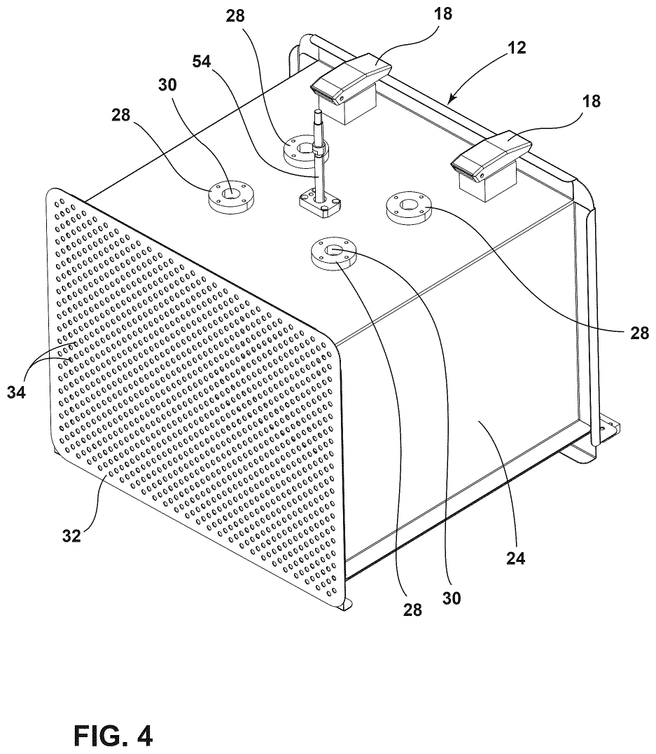

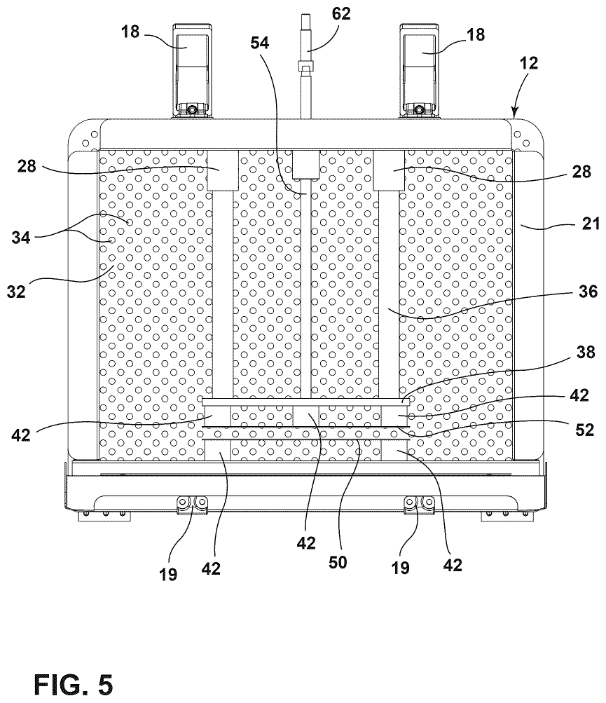

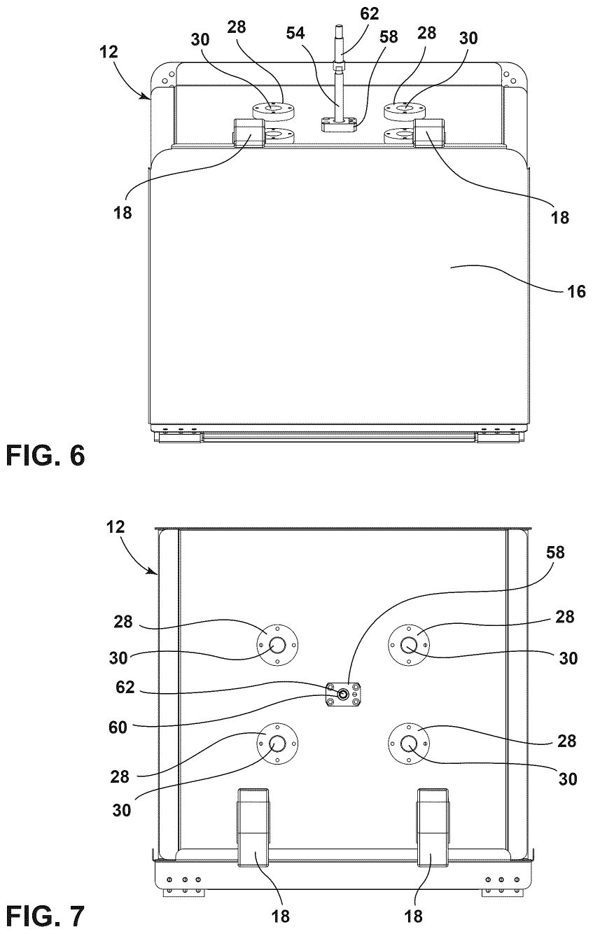

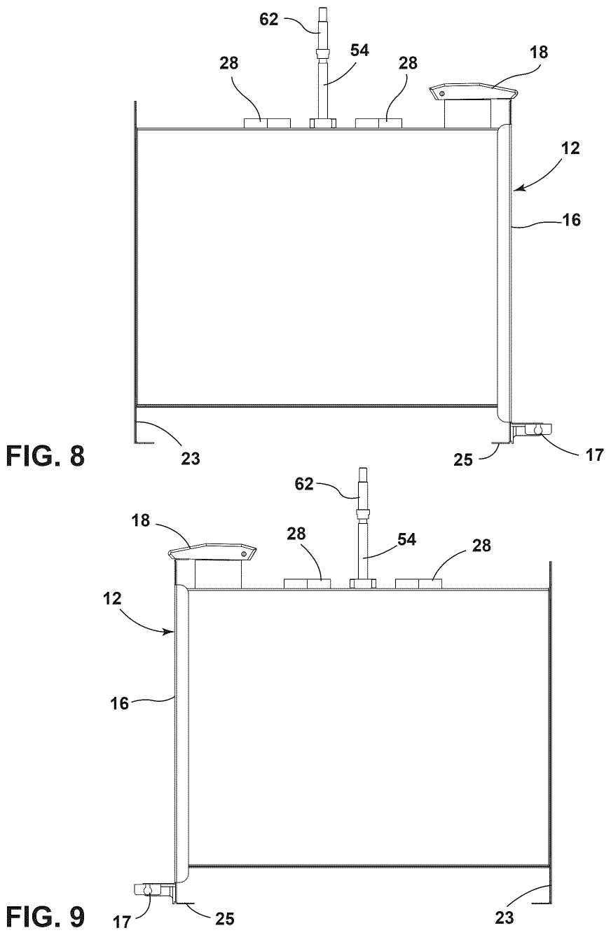

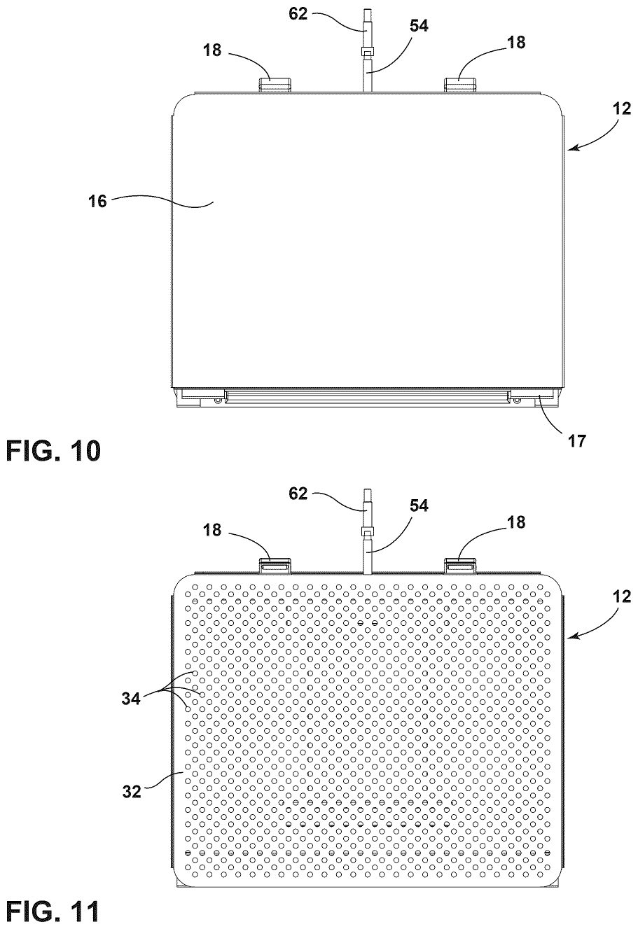

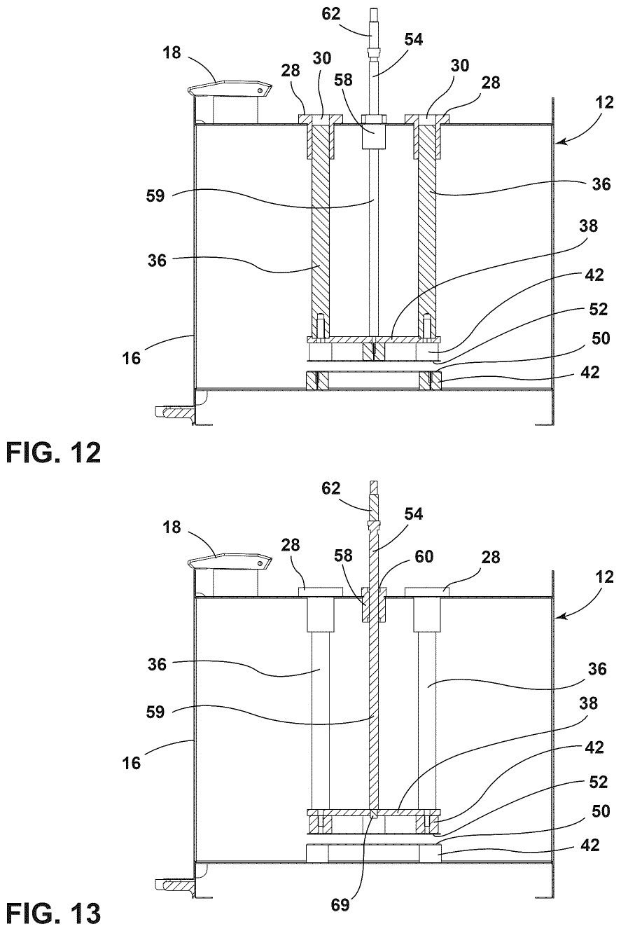

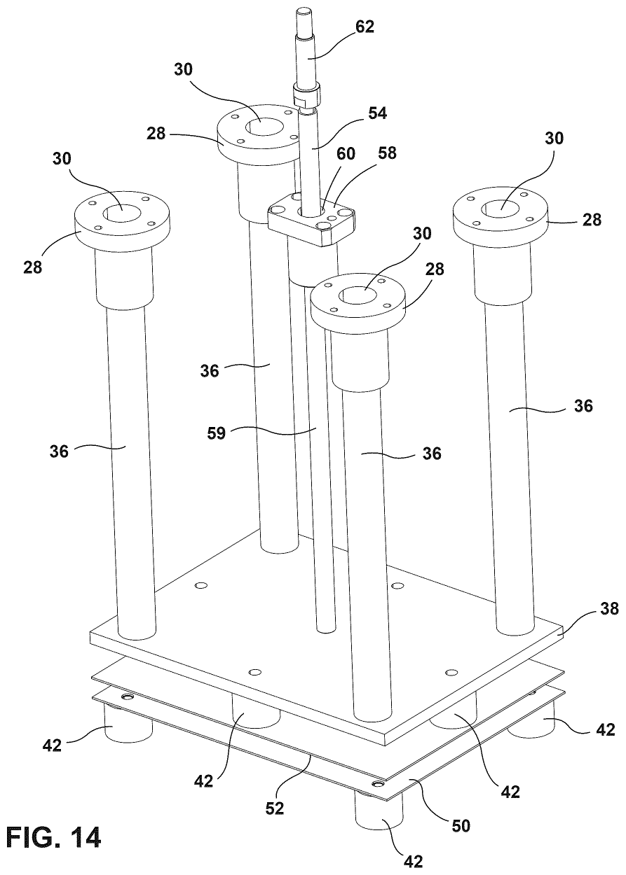

Referring to FIGS. 1-15, reference numeral 12, generally designates a cooking compartment. The cooking compartment can be used to defrost and/or cook food. As illustrated in FIG. 1, the cooking compartment 12 can be placed within a refrigerator 2. The refrigerator 2 can be a conventional refrigerator 2 that includes a freezer compartment 4 and refrigerator compartment 6 enclosed by doors 8 that are coupled to the refrigerator housing 10.

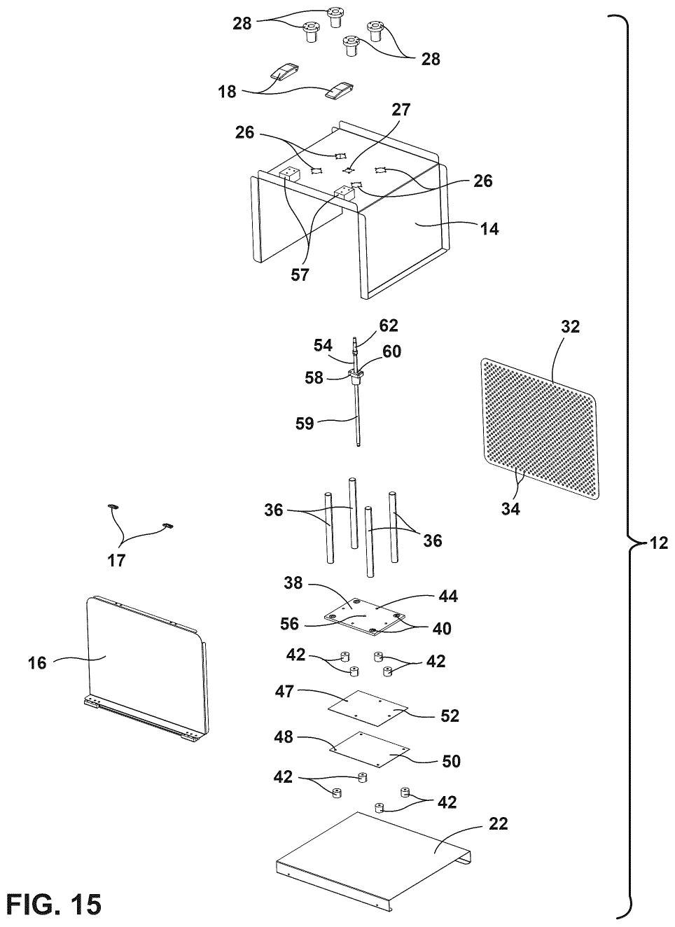

The cooking compartment 12 includes a housing 14. The housing 14 has a top wall 20, a bottom wall 22, side walls 24, and a rear wall 32. The housing 14 can include a front surface 21 that is enclosed by door 16. The door 16 can be coupled to the housing 14 by hinge member 17. The door 16 can include locking members 19 that are captured by latches 18 positioned on the top wall 20 of the housing 14. Latches 18 can be coupled directly to the top wall 20 or can be placed on an intermediate post 57, as illustrated in FIG. 15. A gasket or sealing member can be used between the door 16 and the cooking compartment housing 14 to help seal the cooking compartment 12.

The cooking compartment 12 defrosts and/or heats food by use of radio frequency (RF) generated by an RF signal generator(s) (not shown). The food item is heated between a first electrode 50 and a second electrode 52. One or both of the electrodes 50, 52 can be movable with respect to the other electrode to decrease the distance to place the electrodes 50, 52 close to and/or touching the food. This permits the radio frequency energy to move from one electrode to the other while passing through the food item while also reducing air gaps thereby improving the efficiency of the RF heating. In the illustrated embodiment, the second electrode 52 is the electrode that is movable. One or both of the electrodes 50, 52 can have holes to let moisture escape. In addition, the electrodes 50, 52 can have different shapes, contours, or openings, or be a grid pattern. In the illustrated embodiment, both electrodes 50, 52 are rectangular.

In the illustrated embodiment, the second electrode 52 is movable by use of a ball screw 54. The ball screw member 54 is coupled to the top wall 20 of the housing 14 of the cooking compartment 12 by the ball screw nut 58 that is received in opening 27. The ball screw member includes a shaft 59 that is received within opening 60 in the ball screw nut 58. The ball screw member 54 is also coupled to a plate 38. The ball screw member 54 can include a coupling member 62 that is coupled to coupling member opening 69 on plate 38, as illustrated in FIG. 13.

A number of pins 36 are coupled to the plate 38 and are received within plugs 28 that are coupled to the top wall 20 of the housing 14 of cooking compartment 12. The pins 36 can reciprocate within the openings 30 of the plugs 28 to raise and lower the plate 38 and the second electrode 52 by movement of ball screw member 54. In the illustrated embodiments, there are four pins 36 that are coupled to pin apertures 40 in plate 38, as illustrated in FIG. 15. The plugs 28 are received in openings 26 in the top wall 20 of the housing 14 of cooking compartment 12.

Spacers 42 are positioned between the plate 38 and the second electrode 52. The spacers 42 are coupled to openings 44 in plate 38 and openings 47 in second electrode 52 by coupling mechanisms on spacers 42 and/or fasteners (not shown).

Spacers 42 are also positioned below first electrode 50 to position first electrode 50 above the bottom wall 22 of the cooking compartment 12. The spacers 42 can be coupled to openings 48 on first electrode 50 by coupling features on the spacers 42 and/or fasteners (not shown).

In the illustrated embodiment, the rear wall 32 includes a plurality of openings 30 to permit the moisture generated from the cooking/defrosting of the food item to escape from the cooking compartment 12. The openings 30 can be included on more than one wall and/or on different walls. The moisture can be released to the refrigerator compartment 6 of the refrigerator 2 and/or directed to be released outside of the refrigerator housing 10. Other types of venting may be used in the cooking compartment 12 to remove moisture and/or heat.

The RF signal generator that supplies electrode energy between the first and second electrodes 50, 52 can have a radio frequency of 13.56 MHz and/or 27.12 MHz and power amplifiers in a range of about 100 watts to 500 watts. The RF frequency can be changed depending upon the load, the food item to be heated, the spacing of the electrodes 50,52, a power saving setting, and/or the impedance during the heating operation. The cooking compartment 12 can include the capability of reading the transmitted or reflected power to adjust the output signal in the way that the impedance is properly matched to the load to optimize the transmitted power. The cooking compartment 12 can also be equipped with an interlock system to cut the power to the RF signal generator when the door 16 is opened in order to prevent RF leakage outside of the interior of the cooking compartment 12. The cooking compartment 12 can be equipped directly or indirectly with a user interface to get inputs about the food that is being defrosted. One or more infrared sensors can be included within the cooking compartment 12 to detect food surface initial temperature and to set the proper defrosting signals. The cooking compartment 12 could include a scale on the bottom wall 22 to weigh the food item that is being heated in the cooking compartment 12. A grid, plate and/or griddle can be used to insert and remove food from the cooking compartment. The plate or griddle can have contours to collect fluid that is removed from the food item.

The RF signal generator can be coupled to the cooking compartment 12 or can be installed in another section of refrigerator 2. For example, the RF signal generator could be positioned in the gap that is formed under the bottom wall 22 by the downwardly extending flange 23 and the tab 25. One or more RF signal generators can be used for the electrodes 50, 52.

The spacers 42 can be made of Teflon or similar material and are designed to protect the electrodes 50, 52 from touching each other or other components of the cooking compartment 12 to prevent short circuits and to protect the electrodes 50, 52 amongst other things. The ball screw member 54 and/or the pins 36 can be configured to prevent the second electrode 52 from contacting the first electrode 50. For example, mechanical stops can be present on the pins 36 and/or plugs 28 to prevent the second electrode 52 from contacting the first electrode 50. The ball screw member 54 may be positioned to prevent the second electrode 52 from contacting the first electrode 50. The ball screw member 54 may be connected to a motor to help actuate the ball screw member 54 to move.

In the illustrated embodiments, the second electrode 52 is movable in a vertical manner and the first electrode 50 is positioned above the bottom wall 22. However, the electrodes 50, 52 could be positioned in other places within the cooking compartment 12. For example, the electrodes 50, 52 could be positioned adjacent to the side walls 24 with one or both of the electrodes 50, 52 moving in a horizontal direction. Moreover, while the ball screw member 54 can be activated by a motor, other types of mechanisms can be used to move one or both electrodes 50, 52.

According to another aspect of the present disclosure is a refrigerator with a cooking compartment for radio frequency heating. The refrigerator having an interior cavity. The refrigerator having a cooking compartment having a cooking cavity, with a first electrode positioned in the cooking cavity, and a second electrode position in the cooking cavity. A radio frequency generator supplying electromagnetic energy between said first electrode and said second electrode to heat an object in said cooking cavity. At least one wall of said cooking compartment has a plurality of openings permitting moisture to escape the cooking compartment. At least one of said electrodes is movable with respect to the other electrode.

According to another aspect, the second electrode is movable and positioned above the object to be heated.

According to another aspect, the second electrode is coupled to a plate that is coupled to a plurality of pins that are received within openings in a wall of said cooking compartment.

According to another aspect, the wall is the top wall of said cooking compartment.

According to another aspect, a door is coupled to a front of said cooking compartment.

According to another aspect, spacers are positioned below said first electrode and above said second electrode.

According to another aspect, said wall having a plurality of openings in the back wall of said cooking compartment.

According to another aspect, a ball screw member is coupled to a plate which is coupled to said second electrode to reciprocate the second electrode when the stem reciprocates.

According to another aspect is a cooking compartment for radio frequency heating, having a cooking cavity, a first electrode, and a second electrode. A radio frequency generator supplying electromagnetic energy between said first electrode and said second electrode to heat an object in said cooking cavity. Said first electrode and said second electrode are positioned on opposite sides of said cavity. At least one of said electrodes is in a grid pattern permitting moisture to escape. At least one of said electrodes is movable with respect to the other electrode.

According to another aspect, said second electrode is movable and positioned above an item to be heated.

According to another aspect, said second electrode is coupled to a plurality of pins that are received within openings in a wall of said cooking cavity.

According to another aspect, said wall is the top wall of said cooking cavity.

According to another aspect, a door is coupled to a front of said cooking cavity.

According to another aspect, spacers are positioned below said first electrode and above said second electrode.

According to another aspect, a back wall of said cooking cavity includes a plurality of openings.

According to another aspect, a ball screw member is coupled to a plate which is coupled to said second electrode to reciprocate the second electrode when the stem reciprocates.

According to another aspect, a defrosting compartment for a refrigerator having a cooking cavity, a first electrode, and a second electrode. A radio frequency generator supplying electromagnetic energy between said first electrode and said second electrode to heat an object in said cooking cavity. Said first electrode and said second electrode are positioned on opposite sides of said cavity. Said second electrode is movable with respect to the first electrode. Said second electrode is coupled to a plate that is coupled to a plurality of pins that are received within openings in a wall of said cooking cavity.

According to another aspect, said wall is the top wall of said cooking cavity.

According to another aspect, spacers are positioned below said first electrode and above said second electrode.

According to another aspect, a back wall of said cooking cavity includes a plurality of openings.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A refrigerator with a cooking compartment for radio frequency heating, comprising:
a refrigerator having an interior cavity;
a cooking compartment having a cooking cavity;
a first electrode positioned in the cooking cavity;
a second electrode position in the cooking cavity;
a radio frequency generator supplying electromagnetic energy between said first electrode and said second electrode to heat an object in said cooking cavity;
wherein at least one wall of said cooking compartment has a plurality of openings permitting moisture to escape the cooking compartment; and
wherein at least one of said electrodes is movable with respect to the other electrode.

2. The refrigerator of claim 1, wherein said second electrode is movable and positioned above the object to be heated.

3. The refrigerator of claim 1, wherein said second electrode is coupled to a plate that is coupled to a plurality of pins that are received within openings in a wall of said cooking compartment.

4. The refrigerator of claim 3, wherein said wall is the top wall of said cooking compartment.

5. The refrigerator of claim 1, wherein said radio frequency generator is turned off when said cooking compartment is opened.

6. The refrigerator of claim 1, including spacers positioned adjacent to said first electrode and said second electrode.

7. The refrigerator of claim 1, wherein the radio frequency generator has a radio frequencies of 13.56 MHz and 27.12 MHz and power amplifiers in a range of about 100 watts to 500 watts.

8. The refrigerator of claim 1, including a plate which is coupled to said second electrode.

9. A cooking compartment for radio frequency heating, comprising:
a cooking cavity;
a first electrode;
a second electrode;
a radio frequency generator supplying electromagnetic energy between said first electrode and said second electrode to heat an object in said cooking cavity;
wherein said first electrode and said second electrode are positioned on opposite sides of said cavity;
wherein at least one of said electrodes is in a grid pattern permitting moisture to escape; and
wherein at least one of said electrodes is movable with respect to the other electrode.

10. The cooking compartment of claim 9, wherein said second electrode is movable and positioned above an item to be heated.

11. The cooking compartment of claim 9, wherein said second electrode is coupled to a plurality of pins that are received within openings in a wall of said cooking cavity.

12. The cooking compartment of claim 11, wherein said wall is the top wall of said cooking cavity.

13. The cooking compartment of claim 9, wherein said radio frequency generator is turned off when said cooking cavity is opened.

14. The cooking compartment of claim 9, including spacers adjacent to said first electrode and said second electrode.

15. The cooking compartment of claim 9, wherein a wall of said cooking cavity includes a plurality of openings.

16. The cooking compartment of claim 9, including a plate which is coupled to said second electrode.

17. A defrosting compartment for a refrigerator, comprising:
a cooking cavity;
a first electrode;
a second electrode;
a radio frequency generator supplying electromagnetic energy between said first electrode and said second electrode to heat an object in said cooking cavity;
wherein said first electrode and said second electrode are positioned on opposite sides of said cavity;
wherein said second electrode is movable with respect to the first electrode; and
wherein said second electrode is coupled to a plate that is coupled to a plurality of pins that are received within openings in a wall of said cooking cavity.

18. The defrosting compartment of claim 17, wherein said wall is the top wall of said cooking cavity.

19. The defrosting compartment of claim 17, including spacers adjacent to said first electrode and said second electrode.

20. The defrosting compartment of claim 17, wherein a wall of said cooking cavity includes a plurality of openings.
